(19) United States
(12) Patent Application Publication
(10) Pub. No.: US 2023/0243020 A1
(43) Pub. Date: Aug. 3, 2023

(54) PLASTIC COPPER ALLOY WORKING MATERIAL, COPPER ALLOY WIRE MATERIAL, COMPONENT FOR ELECTRONIC AND ELECTRICAL EQUIPMENT, AND TERMINAL

(71) Applicant: MITSUBISHI MATERIALS CORPORATION, Tokyo (JP)

(72) Inventors: Hirotaka MATSUNAGA, Aizuwakamatsu-shi (JP); Yuki ITO, Ageo-shi (JP); Kosei FUKUOKA, Hokota-shi (JP); Kazunari MAKI, Saitama-shi (JP); Kenji MORIKAWA, Aizuwakamatsu-shi (JP); Shinichi FUNAKI, Aizuwakamatsu-shi (JP); Hiroyuki MORI, Tsukuba-shi (JP)

(73) Assignee: MITSUBISHI MATERIALS CORPORATION, Tokyo (JP)

(21) Appl. No.: 18/003,451

(22) PCT Filed: Jun. 30, 2021
(86) PCT No.: PCT/JP2021/024762

§ 371 Date: Dec. 27, 2022

(30) Foreign Application Priority Data
Jun. 30, 2020 (JP) 2020-112695
Jun. 30, 2020 (JP) 2020-112927
May 31, 2021 (JP) 2021-091160

(51) Int. Cl. C22C 9/00; H01B 1/02; C21D 8/06

(52) U.S. Cl. CPC C22C 9/00; H01B 1/026; C21D 8/06

(57) ABSTRACT

A copper alloy plastically-worked material comprises Mg in the amount of greater than 10 mass ppm and 100 mass ppm or less and a balance of Cu and inevitable impurities, that comprise 10 mass ppm or less of S, 10 mass ppm or less of P, 5 mass ppm or less of Se, 5 mass ppm or less of Te, 5 mass ppm or less of Sb, 5 mass ppm or less of Bi, and 5 mass ppm or less of As. The total amount of S, P, Se, Te, Sb, Bi, and As is 30 mass ppm or less. The mass ratio of [Mg]/[S+P+Se+Te+Sb+Bi+As] is 0.6 or greater and 50 or less, the electrical conductivity is 97% IACS or greater. The tensile strength is 200 MPa or greater. The heat-resistant temperature is 150° C. or higher.

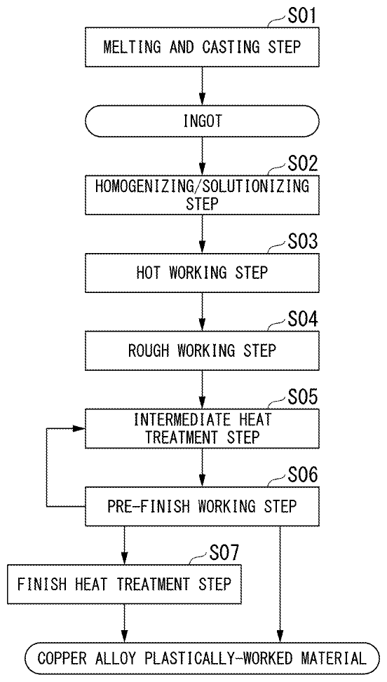

### CROSS-REFERENCE TO RELATED PATENT APPLICATIONS

This application is a U.S. National Phase Application under 35 U.S.C. § 371 of International Patent Application No. PCT/JP2021/024762 filed on Jun. 30, 2021 and claims the benefit of priority to Japanese Patent Applications No. 2020-112695 filed on Jun. 30, 2020, No. 2020-112927 filed on Jun. 30, 2020 and No. 2021-091160 filed on May 31, 201, the contents of all of which are incorporated herein by reference in their entireties. The International Application was published in Japanese on Jan. 6, 2022 as International Publication No. WO/2022/004789 under PCT Article 21(2).

### FIELD OF THE INVENTION

The present invention relates to a copper alloy plastically-worked material suitable for a component for electronic/electrical devices such as a terminal, a copper alloy wire material, a component for electronic/electrical devices, and a terminal.

### BACKGROUND OF THE INVENTION

In the related art, copper wire materials have been used as electrical conductors in various fields. In recent years, terminals consisting of copper wire materials have also been used.

With an increase in current of electronic devices and electrical devices, in order to reduce the current density and diffuse heat due to Joule heat generation, a pure copper material such as oxygen-free copper with excellent electrical conductivity is applied to a component for electronic/electrical devices used for such electronic devices and electrical devices.

In recent years, with an increase in the amount of current used for a component for electronic/electrical devices, the diameter of a copper wire material used for the component for electronic/electrical devices has increased. However, there is a problem in that the weight of the material is increased due to an increase in diameter, which is not preferable for in-vehicle applications from the viewpoint that the weight affects fuel efficiency. Further, with heat generation in a case of electrical conduction and an increase in temperature in a use environment, there is a demand for a copper material with excellent heat resistance indicating that the strength is unlikely to decrease at a high temperature. However, there is a problem in that pure copper materials have insufficient heat resistance and thus are not suitable for use in a high-temperature environment.

Therefore, Japanese Unexamined Patent Application, First Publication No. 2016-056414 discloses a copper rolled plate containing 0.005% by mass or greater and less than 0.1% by mass of Mg.

The copper rolled plate described in Japanese Unexamined Patent Application, First Publication No. 2016-056414 has a composition formed of 0.005% by mass or greater and less than 0.1% by mass of Mg and the balance consisting of Cu and inevitable impurities, and thus the strength and the stress relaxation resistance can be improved by dissolving Mg into the matrix of copper without greatly decreasing the electrical conductivity.

### CITATION LIST

### Patent Document

[Patent Document 1]

Japanese Unexamined Patent Application, First Publication No. 2016-056414

### Technical Problem

Meanwhile, recently, a copper material constituting the component for electronic/electrical devices is required to further improve the electrical conductivity so that the copper material can be used for applications where the pure copper material has been used, in order to sufficiently suppress heat generation in a case where a high current flows.

Further, since the above-described component for electronic/electrical devices is frequently used in a high-temperature environment such as an engine room, the copper material constituting the component for electronic/electrical devices is required to improve the heat resistance more than before. In other words, there is a demand for a copper material with improved strength, electrical conductivity, and heat resistance in a well-balanced manner.

Further, the copper material can be satisfactorily used by sufficiently improving the electrical conductivity even in the applications where a pure copper material has been used in the related art.

The present invention has been made in view of the above-described circumstances, and an objective of the present invention is to provide a copper alloy plastically-worked material, a copper alloy wire material, a component for electronic/electrical devices, and a terminal, which have high strength, high electrical conductivity, and excellent heat resistance.

### SUMMARY OF THE INVENTION

### Solution to Problem

As a result of intensive research conducted by the present inventors in order to achieve the above-described objective, the present inventors found that addition of a small amount of Mg and regulation of the amount of an element generating a compound with Mg are required to achieve the balance between high strength, high electrical conductivity, and excellent heat resistance. That is, the present inventors found that the strength, the electrical conductivity, and the heat resistance can be further improved more than before in a well-balanced manner by regulating the amount of an element generating a compound with Mg and allowing the small amount of Mg that has been added to be present in the copper alloy in an appropriate form.

The present invention has been made based on the above-described findings. According to the present invention, there is provided a copper alloy plastically-worked material which has a composition including greater than 10 mass ppm and 100 mass ppm or less of Mg and the balance consisting of Cu and inevitable impurities, in which in the inevitable impurities, the amount of S is 10 mass ppm or less, the amount of P is 10 mass ppm or less, the amount of Se is 5 mass ppm or less, the amount of Te is 5 mass ppm or less, the amount of Sb is 5 mass ppm or less, the amount of Bi is 5 mass ppm or less, and the amount of As is 5 mass ppm or less, with the total amount of S, P, Se, Te, Sb, Bi, and As being 30 mass ppm or less, and in a case where the amount of Mg is defined as [Mg] and the total amount of S, P, Se, Te, Sb, Bi, and As is defined as [S+P+Se+Te+Sb+Bi+As], the mass ratio of [Mg]/[S+P+Se+Te+Sb+Bi+As] is 0.6 or greater and 50 or less, the electrical conductivity is 97% IACS or greater, the tensile strength is 200 MPa or greater, and the heat-resistant temperature is 150° C. or higher.

According to the copper alloy plastically-worked material with the above-described configuration, since the amount of Mg and the amounts of S, P, Se, Te, Sb, Bi, and As, which are elements generating compounds with Mg, are defined as described above, the heat resistance can be improved by dissolving a small amount of added Mg into the matrix of copper without greatly decreasing the electrical conductivity, specifically, the electrical conductivity can be set to 97% IACS or greater, the tensile strength can be set to 200 MPa or greater, and the heat-resistant temperature can be set to 150° C. or higher, and high strength, high electrical conductivity, and excellent heat resistance can be achieved.

Further, in the present invention, the heat-resistant temperature is a heat treatment temperature, at which a strength reaches 0.8×T₀ with respect to a strength T₀ before a heat treatment, after the heat treatment for a heat treatment time of 60 minutes.

Here, in the copper alloy plastically-worked material of the present invention, it is preferable that the cross-sectional area of the cross section transverse to the longitudinal direction of the copper alloy plastically-worked material is set to be in a range of 50 μm² or greater and 20 mm² or less.

In this case, since the cross-sectional area of the cross section transverse to the longitudinal direction of the copper alloy plastically-worked material is set to be in a range of 50 μm² or greater and 20 mm² or less, the strength and the electrical conductivity can be sufficiently ensured.

Further, in the copper alloy plastically-worked material of the present invention, it is preferable that the amount of Ag is set to be in a range of 5 mass ppm or greater and 20 mass ppm or less.

In this case, since the amount of Ag is in the above-described range, Ag is segregated in the vicinity of grain boundaries, grain boundary diffusion is suppressed, and the heat resistance can be further improved.

Further, in the copper alloy plastically-worked material of the present invention, it is preferable that in the inevitable impurities, the amount of H is 10 mass ppm or less, the amount of 0 is 100 mass ppm or less, and the amount of C is 10 mass ppm or less.

In this case, since the amounts of H, O, and C are defined as described above, generation of defects such as blowholes, Mg oxides, C involvement, and carbides can be reduced, and the strength and the heat resistance can be improved without decreasing the workability.

Further, in the copper alloy plastically-worked material of the present invention, in a case where a measurement area of 1,000 μm² or greater in a cross section transverse to a longitudinal direction of the copper alloy plastically-worked material is ensured and defined as an observation surface of an EBSD method, a measurement point where the CI value at every measurement interval of 0.1 μm is 0.1 or less is removed, the orientation difference between crystal grains is analyzed, a boundary having 15° or greater of the orientation difference between neighboring measurement points is assigned as a crystal grain boundary, an average grain size A is acquired according to Area Fraction, measurement is performed at every measurement interval which is 1/10 or less of the average grain size A, a measurement area of 1,000 μm² or greater in a plurality of visual fields is ensured such that a total of 1,000 or more crystal grains are included, and defined as an observation surface, a measurement point where the CI value analyzed by data analysis software OIM is 0.1 or less is removed and analyzed, and the length of a low-angle grain boundary and a subgrain boundary having 2° or greater and 15° or less of the orientation difference between neighboring measurement points is defined as L_{LB} and the length of a high-angle grain boundary having greater than 15° of the orientation difference between neighboring measurement points is defined as L_{HB}, it is preferable that a relationship of L_{LB}/(L_{LB}+L_{HB})>5% is satisfied.

In this case, since the length L_{LB} of the low-angle grain boundary and the subgrain boundary and the length L_{HB} of the high-angle grain boundary satisfy the relationship described above, the region of the low-angle grain boundary and the subgrain boundary where the density of dislocations introduced during working is high is relatively large, and thus the strength can be further improved due to work hardening accompanied by an increase in dislocation density.

Further, in a case where the cross-sectional area transverse to the longitudinal direction of the copper alloy plastically-worked material is less than 1,000 μm², observation is made in a plurality of visual fields, and the total area of the observation visual fields is set to 1,000 μm² or greater.

Further, in the copper alloy plastically-worked material of the present invention, in a cross section transverse to a longitudinal direction of the copper alloy plastically-worked material, it is preferable that an area ratio of crystals having (100) plane orientation is 60% or less and that an area ratio of crystals having (123) plane orientation is 2% or greater.

In this case, in the cross section transverse to the longitudinal direction of the copper alloy plastically-worked material, since the area ratio of crystals in the (100) plane orientation in which dislocations are unlikely to be accumulated is suppressed to 60% or less and the area ratio of crystals in the (123) plane orientation in which dislocations are likely to be accumulated is ensured to 2% or greater, the strength can be further improved due to work hardening accompanied by an increase in dislocation density.

A copper alloy wire material of the present invention consists of the copper alloy plastically-worked material described above, in which a diameter of a cross section transverse to a longitudinal direction of the copper alloy plastically-worked material is in a range of 10 μm or greater and 5 mm or less.

According to the copper alloy wire material with the above-described configuration, since the copper alloy wire material consists of the copper alloy plastically-worked material described above, the copper alloy wire material can exhibit excellent characteristics even for high-current applications in a high-temperature environment. Further, the diameter of the cross section transverse to the longitudinal direction of the copper alloy plastically-worked material is set to be in a range of 10 μm or greater and 5 mm or less, the strength and the electrical conductivity can be sufficiently ensured.

A component for electronic/electrical devices of the present invention consists of the copper alloy plastically-worked material described above.

The component for electronic/electrical devices with the above-described configuration is produced by using the above-described copper alloy plastically-worked material, and thus the component can exhibit excellent characteristics even in a case of being used for high-current applications in a high-temperature environment.

A terminal of the present invention consists of the copper alloy plastically-worked material described above.

The terminal with the above-described configuration is produced by using the copper alloy plastically-worked material described above, and thus the terminal can exhibit excellent characteristics even in a case of being used for high-current applications in a high-temperature environment.

### Advantageous Effects of Invention

According to the present invention, it is possible to provide a copper alloy plastically-worked material, a copper alloy wire material, a component for electronic/electrical devices, and a terminal, which have high strength, high electrical conductivity, and excellent heat resistance.

### BRIEF DESCRIPTION OF THE DRAWING

The FIGURE is a flow chart showing a method of producing a copper alloy plastically-worked material according to the present embodiment.

### DETAILED DESCRIPTION OF THE INVENTION

Hereinafter, a copper alloy plastically-worked material according to an embodiment of the present invention will be described.

The copper alloy plastically-worked material of the present embodiment has a composition including greater than 10 mass ppm and 100 mass ppm or less of Mg and a balance consisting of Cu and inevitable impurities, in which in the inevitable impurities, the amount of S is 10 mass ppm or less, the amount of P is 10 mass ppm or less, the amount of Se is 5 mass ppm or less, the amount of Te is 5 mass ppm or less, the amount of Sb is 5 mass ppm or less, the amount of Bi is 5 mass ppm or less, and the amount of As is 5 mass ppm or less, with the total amount of S, P, Se, Te, Sb, Bi, and As being 30 mass ppm or less.

Further, in a case where the amount of Mg is defined as [Mg] and the total amount of S, P, Se, Te, Sb, Bi, and As is defined as [S+P+Se+Te+Sb+Bi+As], the mass ratio of [Mg]/[S+P+Se+Te+Sb+Bi+As] is 0.6 or greater and 50 or less.

Further, in the copper alloy plastically-worked material according to the present embodiment, the amount of Ag may be in a range of 5 mass ppm or greater and 20 mass ppm or less.

Further, in the copper alloy plastically-worked material according to the present embodiment, in the inevitable impurities, the amount of H may be 10 mass ppm or less, the amount of 0 may be 100 mass ppm or less, and the amount of C may be 10 mass ppm or less.

Further, in the copper alloy plastically-worked material according to the present embodiment, the electrical conductivity is set to 97% IACS or greater, and the tensile strength is set to 200 MPa or greater.

Further, in the copper alloy plastically-worked material according to the present embodiment, the heat-resistant temperature is set to 150° C. or higher.

In addition, in the copper alloy plastically-worked material of the present embodiment, a measurement area of 1,000 μm² or greater in a cross section transverse to a longitudinal direction of the copper alloy plastically-worked material is ensured and defined as an observation surface of an electron back scattered diffraction (EBSD) method, a measurement point where a confidence index (CI) value at every measurement interval of 0.1 μm is 0.1 or less is removed, the orientation difference between crystal grains is analyzed, a boundary having 15° or greater of the orientation difference between neighboring measurement points is assigned as a crystal grain boundary, and an average grain size A is acquired according to Area Fraction. Next, in a case where the cross section transverse to the longitudinal direction of the copper alloy plastically-worked material is observed similarly by the EBSD method, measurement is performed at every measurement interval which is 1/10 or less of the average grain size A, a measurement area of 1,000 μm² or greater in a plurality of visual fields is ensured such that a total of 1,000 or more crystal grains are included, and defined as an observation surface, a measurement point where the CI value analyzed by data analysis software OIM is 0.1 or less is removed and analyzed, and the length of a low-angle grain boundary and a subgrain boundary having 2° or greater and 15° or less of the orientation difference between neighboring measurement points is defined as L_{LB} and the length of a high-angle grain boundary having greater than 15° of the orientation difference between neighboring measurement points is defined as L_{HB}, it is preferable that a relationship of L_{LB}/(L_{LB}+L_{HB})>5% is satisfied.

Further, in a case where the cross-sectional area transverse to the longitudinal direction of the copper alloy plastically-worked material is less than 1,000 μm², observation is made in a plurality of visual fields, and the total area of the observation visual fields is set to 1,000 μm² or greater.

In addition, the average grain size A is an area average grain size.

Further, in the copper alloy plastically-worked material of the present embodiment, in the cross section transverse to the longitudinal direction of the copper alloy plastically-worked material, it is preferable that the area ratio of crystals having (100) plane orientation is set to 60% or less and that the area ratio of crystals having (123) plane orientation is set to 2% or greater.

Further, in the copper alloy plastically-worked material of the present embodiment, it is preferable that the cross-sectional area of the cross section transverse to the longitudinal direction of the copper alloy plastically-worked material is set to be in a range of 50 μm² or greater and 20 mm² or less.

Further, the copper alloy plastically-worked material of the present embodiment may be a copper alloy wire material in which the diameter of the cross section transverse to the longitudinal direction of the copper alloy plastically-worked material is set to be in a range of 10 μm or greater and 5 mm or less.

Next, in the copper alloy plastically-worked material of the present embodiment, the reason why the component composition, various characteristics, the crystal structure, and the cross-sectional area are specified as described above will be described.

### (Mg)

Mg is an element having an effect of improving the strength and the heat resistance without greatly decreasing the electrical conductivity by being dissolved into the matrix of copper.

Here, in a case where the amount of Mg is 10 mass ppm or less, there is a concern that the effect may not be sufficiently exhibited. On the contrary, in a case where the amount of Mg is greater than 100 mass ppm, the electrical conductivity may be decreased.

As described above, in the present embodiment, the amount of Mg is set to be in a range of greater than 10 mass ppm and 100 mass ppm or less.

In order to further improve the strength and the heat resistance, the lower limit of the amount of Mg is set to preferably 20 mass ppm or greater, more preferably 30 mass ppm or greater, and still more preferably 40 mass ppm or greater.

Further, in order to further suppress a decrease in the electrical conductivity, the upper limit of the amount of Mg is set to preferably less than 90 mass ppm, more preferably less than 80 mass ppm, and still more preferably less than 70 mass ppm.

### (S, P, Se, Te, Sb, Bi, and As)

The elements such as S, P, Se, Te, Sb, Bi, and As described above are elements that typically exist in a copper alloy. These elements are likely to react with Mg to form a compound, and thus may reduce the solid-solution effect of a small amount of added Mg. Therefore, the amount of these elements is required to be strictly controlled.

Therefore, in the present embodiment, the amount of S is limited to 10 mass ppm or less, the amount of P is limited to 10 mass ppm or less, the amount of Se is limited to 5 mass ppm or less, the amount of Te is limited to 5 mass ppm or less, the amount of Sb is limited to 5 mass ppm or less, the amount of Bi is limited to 5 mass ppm or less, and the amount of As is limited to 5 mass ppm or less.

Further, the total amount of S, P, Se, Te, Sb, Bi, and As is limited to 30 mass ppm or less.

Further, the amount of S is preferably 9 mass ppm or less and more preferably 8 mass ppm or less.

The amount of P is preferably 6 mass ppm or less and more preferably 3 mass ppm or less.

The amount of Se is preferably 4 mass ppm or less and more preferably 2 mass ppm or less.

The amount of Te is preferably 4 mass ppm or less and more preferably 2 mass ppm or less.

The amount of Sb is preferably 4 mass ppm or less and more preferably 2 mass ppm or less.

The amount of Bi is preferably 4 mass ppm or less and more preferably 2 mass ppm or less.

The amount of As is preferably 4 mass ppm or less and more preferably 2 mass ppm or less.

The lower limit of the amount of the above-described elements is not particularly limited, but the amount of each of S, P, Sb, Bi, and As is preferably 0.1 mass ppm or greater, the amount of Se is preferably 0.05 mass ppm or greater, and the amount of Te is preferably 0.01 mass ppm or greater from the viewpoint that the production cost is increased in order to greatly reduce the amount of the above-described elements.

Further, the total amount of S, P, Se, Te, Sb, Bi, and As is preferably 24 mass ppm or less and more preferably 18 mass ppm or less. The lower limit of the total amount of S, P, Se, Te, Sb, Bi, and As is not particularly limited, but the total amount of S, P, Se, Te, Sb, Bi, and As is 0.6 mass ppm or greater and more preferably 0.8 mass ppm or greater from the viewpoint that the production cost is increased in order to greatly reduce the total amount thereof.

### ([Mg]/[S+P+Se+Te+Sb+Bi+As])

As described above, since elements such as S, P, Se, Te, Sb, Bi, and As easily react with Mg to form compounds, the form of presence of Mg is controlled by defining the ratio between the amount of Mg and the total amount of S, P, Se, Te, Sb, Bi, and As in the present embodiment.

In a case where the amount of Mg is defined as [Mg] and the total amount of S, P, Se, Te, Sb, Bi, and As is defined as [S+P+Se+Te+Sb+Bi+As], Mg is excessively present in copper in a solid solution state, and thus the electrical conductivity may be decreased in a case where the mass ratio of [Mg]/[S+P+Se+Te+Sb+Bi+As] is greater than 50. On the contrary, in a case where the mass ratio of [Mg]/[S+P+Se+Te+Sb+Bi+As] is less than 0.6, Mg is not sufficiently dissolved into copper, and thus the heat resistance may not be sufficiently improved.

Therefore, in the present embodiment, the mass ratio of [Mg]/[S+P+Se+Te+Sb+Bi+As] is set to be in a range of 0.6 or greater and 50 or less.

In addition, the amount of each element in the above-described mass ratio is in units of mass ppm.

In order to further suppress a decrease in electrical conductivity, the upper limit of the mass ratio of [Mg]/[S+P+Se+Te+Sb+Bi+As] is preferably 35 or less and more preferably 25 or less.

Further, in order to further improve the heat resistance, the lower limit of the mass ratio of [Mg]/[S+P+Se+Te+Sb+Bi+As] is set to preferably 0.8 or greater and more preferably 1.0 or greater.

### (Ag: 5 Mass Ppm or Greater and 20 Mass Ppm or Less)

Ag is unlikely to be dissolved into the Cu matrix in a temperature range of 250° C. or lower, in which typical electronic/electrical devices are used. Therefore, a small amount of Ag added to copper segregates in the vicinity of grain boundaries. In this manner, since movement of atoms at grain boundaries is disturbed and grain boundary diffusion is suppressed, the heat resistance is improved.

Here, in a case where the amount of Ag is 5 mass ppm or greater, the effects can be sufficiently exhibited. On the contrary, in a case where the amount of Ag is 20 mass ppm or less, the electrical conductivity can be ensured and an increase in production cost can be suppressed.

As described above, in the present embodiment, the amount of Ag is set to be in a range of 5 mass ppm or greater and 20 mass ppm or less.

In order to further improve the heat resistance, the lower limit of the amount of Ag is set to preferably 6 mass ppm or greater, more preferably 7 mass ppm or greater, and still more preferably 8 mass ppm or greater. Further, in order to reliably suppress a decrease in the electrical conductivity and an increase in cost, the upper limit of the amount of Ag is set to preferably 18 mass ppm or less, more preferably 16 mass ppm or less, and still more preferably 14 mass ppm or less.

Further, in a case where Ag is not intentionally included and the impurities include Ag, the amount of Ag may be less than 5 mass ppm.

### (H: 10 Mass Ppm or Less)

H is an element that combines with O to form water vapor in a case of casting and causes blowhole defects in an ingot. The blowhole defects cause defects such as breaking in a case of casting and blistering and peeling in a case of working. The defects such as breaking, blistering, and peeling are known to degrade the strength and the surface quality because the defects are the starting point of fractures due to stress concentration.

Here, the occurrence of blowhole defects described above is suppressed by setting the amount of H to 10 mass ppm or less, and deterioration of cold workability can be suppressed.

In order to further suppress the occurrence of blowhole defects, the amount of H is set to preferably 4 mass ppm or less and more preferably 2 mass ppm or less. The lower limit of the amount of H is not particularly limited, but the amount of H is preferably 0.01 mass ppm or greater from the viewpoint that the production cost is increased in order to greatly reduce the amount of H.

### (O: 100 Mass Ppm or Less)

O is an element that reacts with each component element in the copper alloy to form an oxide. Since such oxides serve as the starting point for fractures, workability is degraded, which makes the production difficult. Further, in a case where an excessive amount of O reacts with Mg, Mg is consumed, the amount of solid solution of Mg into the Cu matrix is decreased, and thus the strength, the heat resistance, or the cold workability may be degraded.

Here, the generation of oxides and the consumption of Mg are suppressed by setting the amount of O to 100 mass ppm or less, and thus the workability can be improved.

Further, the amount of O is particularly preferably 50 mass ppm or less and more preferably 20 mass ppm or less, even within the above-described range. The lower limit of the amount of 0 is not particularly limited, but the amount of 0 is preferably 0.01 mass ppm or greater from the viewpoint that the production cost is increased in order to greatly reduce the amount of 0.

### (C: 10 Mass Ppm or Less)

C is an element that is used to coat the surface of a molten metal in a case of melting and casting for the objective of deoxidizing the molten metal and thus may inevitably be mixed. The amount of C may increase due to C inclusion during casting. The segregation of C, a composite carbide, and a solid solution of C degrades the cold workability.

Here, in a case where the amount of C is set to 10 mass ppm or less, occurrence of segregation of C, a composite carbide, and a solid solution of C can be suppressed, and cold workability can be improved.

Further, the amount of C is set to preferably 5 mass ppm or less and more preferably 1 mass ppm or less, even within the above-described range. The lower limit of the amount of C is not particularly limited, but the amount of C is preferably 0.01 mass ppm or greater from the viewpoint that the production cost is increased in order to greatly reduce the amount of C.

### (Other Inevitable Impurities)

Examples of other inevitable impurities in addition to the above-described elements include Al, B, Ba, Be, Ca, Cd, Cr, Sc, rare earth elements, V, Nb, Ta, Mo, Ni, W, Mn, Re, Ru, Sr, Ti, Os, Co, Rh, Ir, Pb, Pd, Pt, Au, Zn, Zr, Hf, Hg, Ga, In, Ge, Y, Tl, N, Si, Sn, and Li. The copper alloy may contain inevitable impurities within a range not affecting the characteristics.

Here, since there is a concern that the electrical conductivity is decreased, it is preferable that the amount of the inevitable impurities is reduced.

### (Tensile Strength: 200 MPa or Greater)

In the copper alloy plastically-worked material of the present embodiment, in a case where the tensile strength of the copper alloy plastically-worked material in a direction parallel to the longitudinal direction (wire-drawing direction) is 200 MPa or greater, the copper alloy plastically-worked material can be used in a wide range of cross-sectional areas.

Further, the upper limit of the tensile strength is not particularly limited, but it is preferable that the tensile strength is set to 450 MPa or less from the viewpoint of avoiding a decrease in productivity due to a winding habit of coil in a case where coil winding of the copper alloy plastically-worked material (wire material) is performed.

Further, the tensile strength of the copper alloy plastically-worked material in the direction parallel to the longitudinal direction (wire-drawing direction) is more preferably 245 MPa or greater, still more preferably 275 MPa or greater, and most preferably 300 MPa or greater.

Further, the tensile strength of the copper alloy plastically-worked material in the direction parallel to the longitudinal direction (wire-drawing direction) is preferably 500 MPa or less and more preferably 480 MPa or less.

### (Electrical Conductivity: 97% IACS or Greater)

In the copper alloy plastically-worked material according to the present embodiment, the electrical conductivity is 97% IACS or greater. The heat generation in a case of electrical conduction is suppressed by setting the electrical conductivity to 97% IACS or greater so that the copper alloy plastically-worked material can be satisfactorily used as a component for electronic/electrical devices such as a terminal as a substitute to a pure copper material.

Further, the electrical conductivity is preferably 97.5% IACS or greater, more preferably 98.0% IACS or greater, still more preferably 98.5% IACS or greater, and even still more preferably 99.0% IACS or greater. The upper limit of the electrical conductivity is not particularly limited, but is preferably 103.0% IACS or less and more preferably 102.5% IACS or less.

### (Heat-Resistant Temperature: 150° C. or Higher)

In the copper alloy plastically-worked material of the present embodiment, in a case where the heat-resistant temperature defined by the tensile strength of the copper alloy plastically-worked material in the longitudinal direction (wire-drawing direction) is high, since a softening phenomenon due to recovery and recrystallization of the copper material is unlikely to occur even at a high temperature, the copper alloy plastically-worked material can be applied to an electric conductive member used in a high-temperature environment.

Therefore, in the present embodiment, the heat-resistant temperature is set to 150° C. or higher. Further, in the present embodiment, the heat-resistant temperature is a heat treatment temperature, at which a strength reaches 0.8×T₀ with respect to a strength T₀ before a heat treatment, after the heat treatment at 100° C. to 800° C. for a heat treatment time of 60 minutes.

Here, the heat-resistant temperature is more preferably 175° C. or higher, still more preferably 200° C. or higher, and even still more preferably 225° C. or higher. In addition, the heat-resistant temperature is preferably 600° C. or lower and more preferably 580° C. or lower.

(Low-Angle Grain Boundary and Subgrain Boundary Length Ratio L_{LB}/(L_{LB}+L_{HB}): Greater than 5%)

At grain boundaries, since the low-angle grain boundaries and the subgrain boundaries are regions with a high density of dislocations introduced during working, the strength can be further improved due to work hardening accompanied by an increase in dislocation density by controlling the texture such that the low-angle grain boundary and subgrain boundary length ratio in all grain boundaries L_{LB}/(L_{LB}+L_{HB}) is set to greater than 5%.

Further, the low-angle grain boundary and subgrain boundary length ratio L_{LB}/(L_{LB}+L_{HB}) is more preferably 10% or greater, still more preferably 20% or greater, and even still more preferably 30% or greater.

In addition, in order to reliably suppress the degradation of the heat resistance due to recrystallization in a high-temperature environment and the softening accompanied by the recrystallization caused by high-speed diffusion of atoms via dislocations as a path, the low-angle grain boundary and subgrain boundary length ratio L_{LB}/(L_{LB}+L_{HB}) is preferably 80% or less and more preferably 70% or less.

(Area Ratio of Crystals Having (100) Plane Orientation: 60% or Less)

In the copper alloy plastically-worked material according to the present embodiment, in a case where the crystal orientation in a cross section transverse to the longitudinal direction (wire-drawing direction) of the copper alloy plastically-worked material is measured, the area ratio of crystals having (100) plane orientation is preferably 60% or less. Here, in the present embodiment, the crystal orientation within 15° from the (100) plane is defined as the (100) plane orientation.

Since dislocations in a case of crystal grains in the (100) plane orientation are less likely to be accumulated than those of crystal grains in another orientation, the strength (yield strength) can be improved due to work hardening accompanied by an increase in dislocation density by limiting the area ratio of crystals in the (100) plane orientation to 60% or less.

Further, the area ratio of crystals in the (100) plane orientation is more preferably 50% or less, still more preferably 40% or less, even still more preferably 30% or less, and even still more preferably 20% or less. Further, in order to suppress occurrence of breaking and large wrinkles during coil winding, it is preferable that the area ratio of crystals in the (100) plane orientation is set to 10% or greater.

### (Area Ratio of Crystals Having (123) Plane Orientation: 2% or Greater)

In the copper alloy plastically-worked material according to the present embodiment, in a case where the crystal orientation in a cross section transverse to the longitudinal direction (wire-drawing direction) of the copper alloy plastically-worked material is measured, the area ratio of crystals having (123) plane orientation is preferably 2% or greater. Here, in the present embodiment, the crystal orientation within 15° from the (123) plane is defined as the (123) plane orientation.

Since dislocations in a case of crystal grains in the (123) plane orientation are likely to be accumulated than those of crystal grains in another orientation, the strength (yield strength) can be improved due to work hardening accompanied by an increase in dislocation density by setting the area ratio of crystals in the (123) plane orientation to 2% or greater.

Further, the area ratio of crystals in the (123) plane orientation is more preferably 5% or greater, still more preferably 10% or greater, and even still more preferably 20% or greater.

In addition, in order to suppress the degradation of the heat resistance due to recrystallization in a high-temperature environment and the softening accompanied by the recrystallization caused by high-speed diffusion of atoms via dislocations as a path, the area ratio of crystals in the (123) plane orientation is preferably 90% or less, more preferably 80% or less, and still more preferably 70% or less.

(Cross-Sectional Area: 50 μm² or Greater and 20 mm² or Less)

In the copper alloy plastically-worked material according to the present embodiment, in a case where the cross-sectional area of a cross section transverse to the longitudinal direction of the copper alloy plastically-worked material is in a range of 50 μm² or greater and 20 mm² or less, the copper alloy plastically-worked material has excellent electrical conductivity and excellent strength, and thus the reliability of the copper alloy plastically-worked material is improved.

Further, the cross-sectional area of the cross section transverse to the longitudinal direction of the copper alloy plastically-worked material is more preferably 75 μm² or greater, still more preferably 80 μm² or greater, and even still more preferably 85 μm² or greater. Further, the cross-sectional area of the cross section transverse to the longitudinal direction of the copper alloy plastically-worked material is more preferably 18 mm² or less, still more preferably 16 mm² or less, and even still more preferably 14 mm² or less.

Next, a method of producing the copper alloy plastically-worked material according to the present embodiment with such a configuration will be described with reference to the flow chart of the drawing.

### (Melting and Casting Step S01)

First, the above-described elements are added to molten copper obtained by melting the copper raw material to adjust components; and thereby, a molten copper alloy is produced. Further, a single element, a base alloy, or the like can be used for addition of various elements. In addition, raw materials containing the above-described elements may be melted together with the copper raw material. Further, a recycled material or a scrap material of the alloy may be used.

As the copper raw material, so-called 4N Cu having a purity of 99.99% by mass or greater or so-called 5N Cu having a purity of 99.999% by mass or greater is preferably used. In a case where the amounts of H, O, and C are defined as described above, raw material with low contents of these elements is selected and used. Specifically, it is preferable to use a raw material having a H amount of 0.5 mass ppm or less, an O amount of 2.0 mass ppm or less, and a C amount of 1.0 mass ppm or less.

In order to suppress oxidation of Mg and to reduce the hydrogen concentration in a case of melting, it is preferable that the melting is carried out in an atmosphere using an inert gas atmosphere (for example, Ar gas) in which the vapor pressure of H₂O is low and the holding time for the melting is set to the minimum.

Further, the molten copper alloy in which the components have been adjusted is injected into a mold to produce an ingot. In consideration of mass production, it is preferable to use a continuous casting method or a semi-continuous casting method.

### (Homogenizing/Solutionizing Step S02)

Next, a heat treatment is performed for homogenization and solutionization of the obtained ingot. An intermetallic compound or the like containing Cu and Mg as main components may be present inside the ingot, generated by segregation and concentration of Mg in the solidification process. Therefore, in order to eliminate or reduce the segregated elements and the intermetallic compound, Mg is homogeneously diffused or Mg is dissolved into the matrix in the ingot by performing a heat treatment of heating the ingot to 300° C. or higher and 1,080° C. or lower. In addition, it is preferable that the homogenizing/solutionizing step S02 is performed in a non-oxidizing or reducing atmosphere.

Here, in a case where the heating temperature is lower than 300° C., the solutionization may be incomplete, and a large amount of the intermetallic compound containing Cu and Mg as main components may remain in the matrix. On the contrary, in a case where the heating temperature is higher than 1,080° C., a part of the copper material serves a liquid phase, and thus the texture and the surface state may be uneven. Therefore, the heating temperature is set to be in a range of 300° C. or higher and 1,080° C. or lower.

### (Hot Working Step S03)

The obtained ingot is heated to a predetermined temperature and subjected to hot working in order to homogenize the texture. The working method is not particularly limited, and for example, drawing, extrusion, or groove rolling can be employed.

In the present embodiment, hot extrusion working is performed. Further, it is preferable that the hot extrusion temperature is set to be in a range of 600° C. or higher and 1,000° C. or lower. In addition, it is preferable that the extrusion ratio is set to be in a range of 23 or greater and 6,400 or less.

### (Rough Working Step S04)

In order to work in a predetermined shape, rough working is performed. Further, the temperature conditions for this rough working step S04 are not particularly limited, but the working temperature is set to be preferably in a range of −200° C. to 200° C., in which cold rolling or warm rolling is carried out, and particularly preferably room temperature from the viewpoint of suppressing recrystallization or improving the dimensional accuracy. The working rate is preferably 20% or greater and more preferably 30% or greater. Further, for example, drawing, extruding, or groove rolling can be employed as the working method.

### (Intermediate Heat Treatment Step S05)

After the rough working step S04, an intermediate heat treatment is performed for softening to improve the workability or for obtaining a recrystallized texture.

Here, a heat treatment in a continuous annealing furnace for a short period of time is preferable, and localization of Ag segregation to grain boundaries can be prevented in a case where Ag is added. The heat treatment temperature is preferably in a range of 200° C. or higher and 800° C. or lower and the heat treatment time is preferably in a range of 5 seconds or longer and 24 hours or shorter. In addition, the intermediate heat treatment step S05 and the pre-finish working step S06 described below may be repeatedly performed.

In addition, the localization of grain boundary segregation can be suppressed by controlling the temperature increasing rate and the temperature decreasing rate in continuous annealing, and the texture (area ratio of crystals having the (100) plane orientation and the area ratio of crystals having the (123) plane orientation) formed in the pre-finish working step S06 can be controlled to be in a preferable range.

Here, the temperature increasing rate during the heat treatment in continuous annealing is preferably 2° C./sec or greater, more preferably 5° C./sec or greater, and still more preferably 7° C./sec or greater. Further, the temperature decreasing rate is preferably 5° C./sec or greater, more preferably 7° C./sec or greater, and still more preferably 10° C./sec or greater.

It is preferable to reduce oxidation of contained elements. In order to reduce the oxidation, the oxygen partial pressure is set to preferably 10⁻⁵ atm or less, more preferably 10⁻⁷ atm or less, and still more preferably 10⁻⁹ atm or less.

### (Pre-Finish Working Step S06)

Cold working is performed in order to improve the strength of the copper material using work hardening after the intermediate heat treatment step S05 and to work the copper material into a wire material having a predetermined shape. In order to suppress recrystallization during working or to suppress softening, the temperature is preferably set to be in a range of −200° C. to 200° C. where cold working or warm working is performed and particularly preferably set to room temperature. Further, the working rate is appropriately selected such that the shape of the copper material is close to the final shape, but is set to preferably 5% or greater, more preferably 25% or greater, and still more preferably 50% or greater in order to increase the low-angle grain boundary and the subgrain boundary length ratio while the area ratio of crystals having the (100) plane orientation and the area ratio of crystals having the (123) plane orientation in the pre-finish working step S06 are controlled and to improve the strength due to work hardening.

Further, the texture (area ratio of crystals having the (100) plane orientation and the area ratio of crystals having the (123) plane orientation) can be controlled to be in a preferable range by combining the intermediate heat treatment step S05 and the pre-finish working step S06.

In addition, in order to suppress non-uniformity of the texture due to recrystallization during working, the area reduction ratio in a case of draw working is set to preferably 99.99% or less, more preferably 99.9% or less, and still more preferably 99% or less. Further, drawing, extrusion, groove rolling, or the like can be employed as the working method for working the wire material.

Further, the intermediate heat treatment step S05 and the pre-finish working step S06 may be repeatedly performed.

### (Finish Heat Treatment Step S07)

Finally, a finish heat treatment may be performed in order to refine the copper material after the pre-finish working step S06. In the heat treatment here, a heat treatment that does not cause recrystallization is preferable, and the material characteristics can be adjusted by appropriately causing a recovery phenomenon. The heat treatment method is not particularly limited, and examples of the heat treatment method include continuous annealing and batch annealing, and a reducing atmosphere is preferable as the heat treatment atmosphere. Further, the heat treatment temperature and the time are not particularly limited, but examples of the condition of the heat treatment temperature and the time include holding at 200° C. for 1 hour and holding at 350° C. for 1 second.

In this manner, the copper alloy plastically-worked material (copper alloy wire material) according to the present embodiment is produced.

In the copper alloy plastically-worked material according to the present embodiment with the above-described configuration, since the amount of Mg is set to be in a range of greater than 10 mass ppm and 100 mass ppm or less, and the amount of S is set to 10 mass ppm or less, the amount of P is set to 10 mass ppm or less, the amount of Se is set to 5 mass ppm or less, the amount of Te is set to 5 mass ppm or less, the amount of Sb is set to 5 mass ppm or less, the amount of Bi is set to 5 mass ppm or less, the amount of As is set to 5 mass ppm or less, and the total amount of S, P, Se, Te, Sb, Bi, and As, which are the elements generating compounds with Mg, is limited to 30 mass ppm or less, a small amount of added Mg can be dissolved into the matrix of copper, and the strength and the heat resistance can be improved without greatly decreasing the electrical conductivity.

Further, in a case where the amount of Mg is defined as [Mg] and the total amount of S, P, Se, Te, Sb, Bi, and As is defined as [S+P+Se+Te+Sb+Bi+As], since the mass ratio of [Mg]/[S+P+Se+Te+Sb+Bi+As] is set to be in a range of 0.6 or greater and 50 or less, the strength and the heat resistance can be sufficiently improved without decreasing the electrical conductivity due to dissolution of an excessive amount of Mg.

Therefore, according to the copper alloy of the present embodiment, the electrical conductivity can be set to 97% IACS or greater, the tensile strength can be set to 200 MPa or greater, and the heat-resistant temperature can be set to 150° C. or higher, and high strength, high electrical conductivity, and excellent heat resistance can be achieved.

Further, in the copper alloy plastically-worked material of the present embodiment, in a case where the cross-sectional area of the cross section transverse to the longitudinal direction of the copper alloy plastically-worked material is set to be in a range of 50 μm² or greater and 20 mm² or less, the strength and the electrical conductivity can be sufficiently ensured.

Further, in the copper alloy plastically-worked material according to the present embodiment, in a case where the amount of Ag is set to be in a range of 5 mass ppm or greater and 20 mass ppm or less, since Ag is segregated in the vicinity of grain boundaries and grain boundary diffusion is suppressed by Ag, the heat resistance can be further improved.

Further, in the copper alloy plastically-worked material of the present embodiment, in a case where among the inevitable impurities, the amount of H is set to 10 mass ppm or less, the amount of 0 is set to 100 mass ppm or less, and the amount of C is set to 10 mass ppm or less, generation of defects such as blowholes, Mg oxides, C involvement, and carbides can be reduced, and the strength and the heat resistance can be improved without decreasing the workability.

Further, in the copper alloy plastically-worked material of the present embodiment, in a case where a measurement area of 1,000 μm² or greater in a cross section transverse to a longitudinal direction of the copper alloy plastically-worked material is ensured and defined as an observation surface of an EBSD method, a measurement point where the CI value at every measurement interval of 0.1 μm is 0.1 or less is removed, the orientation difference between crystal grains is analyzed, a boundary having 15° or greater of the orientation difference between neighboring measurement points is assigned as a crystal grain boundary, an average grain size A is acquired according to Area Fraction, measurement is performed at every measurement interval which is 1/10 or less of the average grain size A, a measurement area of 1,000 μm² or greater in a plurality of visual fields is ensured such that a total of 1,000 or more crystal grains are included, and defined as an observation surface, a measurement point where the CI value analyzed by data analysis software OIM is 0.1 or less is removed and analyzed, and the length of a low-angle grain boundary and a subgrain boundary having 2° or greater and 15° or less of the orientation difference between neighboring measurement points is defined as L_{LB} and the length of a high-angle grain boundary having greater than 15° of the orientation difference between neighboring measurement points is defined as L_{HB}, a relationship of L_{LB}/(L_{LB}+L_{HB})>5% is satisfied. In this case, the region of the low-angle grain boundary and the subgrain boundary where the density of dislocations introduced during working is high is relatively large, and thus the strength can be further improved due to work hardening accompanied by an increase in dislocation density.

Further, in the copper alloy plastically-worked material of the present embodiment, in a case where the ratio of the (100) plane is set to 60% or less and the ratio of the (123) plane is set to 2% or greater as a result of measurement of the crystal orientation in the cross section transverse to the longitudinal direction of the copper alloy plastically-worked material, since the ratio of the (100) plane in which dislocations are unlikely to be accumulated is suppressed to 60% or less and the ratio of the (123) plane in which dislocations are likely to be accumulated is ensured to 2% or greater, the strength can be further improved due to work hardening accompanied by an increase in dislocation density.

Further, since the copper alloy wire material of the present embodiment is formed of the copper alloy plastically-worked material described above, excellent characteristics can be exhibited even in a case of being used for high-current applications in a high-temperature environment. Further, the diameter of the cross section transverse to the longitudinal direction of the copper alloy plastically-worked material is set to be in a range of 10 μm or greater and 5 mm or less, the strength and the electrical conductivity can be sufficiently ensured.

Further, the component for electronic/electrical devices (such as a terminal) according to the present embodiment is formed of the above-described copper alloy plastically-worked material, and thus can exhibit excellent characteristics even in a case of being used for high-current applications in a high-temperature environment.

Hereinbefore, the copper alloy plastically-worked material and the component for electronic/electrical devices (such as a terminal) according to the embodiment of the present invention have been described, but the present invention is not limited thereto and can be appropriately changed within a range not departing from the technical features of the invention.

For example, in the above-described embodiment, the example of the method of producing the copper alloy plastically-worked material has been described, but the method of producing the copper alloy plastically-worked material is not limited to the description of the embodiment, and the copper alloy plastically-worked material may be produced by appropriately selecting a production method of the related art.

### Examples

Hereinafter, results of a verification test conducted to verify the effects of the present invention will be described.

A copper raw material in which the amount of H was 0.1 mass ppm or less, the amount of 0 was 1.0 mass ppm or less, the amount of S was 1.0 mass ppm or less, the amount of C was 0.3 mass ppm or less, and the purity of Cu was 99.99% by mass or greater, and a base alloy of each of various additive elements, containing 1% by mass of various additive elements prepared by using a high-purity copper with 6N (purity of 99.9999% by mass) or greater and a pure metal of various additive elements with a purity of 2N (purity of 99% by mass) or greater were prepared.

The copper raw material was put into a crucible and subjected to high-frequency melting in an atmosphere furnace having an Ar gas atmosphere or an Ar—O₂ gas atmosphere.

Each component composition listed in Tables 1 and 2 was prepared using the above-described base alloy in the obtained molten copper, and in a case where H and O were introduced, the atmosphere during melting was prepared as an Ar-N₂-H₂ and Ar—O₂-mixed gas atmosphere using high-purity Ar gas (dew point of −80° C. or lower), high-purity N₂ gas (dew point of −80° C. or lower), high-purity O₂ gas (dew point of −80° C. or lower), and high-purity H₂ gas (dew point of −80° C. or lower). In a case where C was introduced, the surface of the molten metal was coated with C particles during melting and brought into contact with the molten metal.

In this manner, alloy molten metals having the component composition listed in Tables 1 and 2 were melted and poured into a carbon mold to produce an ingot. Further, the size of the ingot was set such that the diameter was approximately 50 mm and the length was approximately 300 mm.

The obtained ingot was subjected to the homogenizing/solutionizing step of performing heating in an Ar gas atmosphere under the heat treatment conditions listed in Tables 3 and 4.

Thereafter, the ingot was subjected to hot working (hot extrusion) under the conditions listed in Tables 3 and 4, thereby obtaining a hot worked material. Further, the hot worked material was cooled by water cooling after the hot working.

The obtained hot worked material was cut, and the surface was ground to remove the oxide film.

Thereafter, rough working (groove rolling) was performed at room temperature under the conditions listed in Tables 3 and 4, thereby obtaining an intermediate material (rod material).

Further, the obtained intermediate worked material (rod material) was subjected to an intermediate heat treatment using a salt bath under the temperature conditions listed in Tables 3 and 4. Thereafter, the material was subjected to water quenching and air cooling. Further, the temperature increasing rate in the salt bath was 10° C./sec or greater, the temperature decreasing rate during the water quenching was 10° C./sec or greater, and the temperature decreasing rate during the air cooling was 5° C. to 10° C./sec.

Next, draw working (wire-drawing working) was carried out as pre-finish working to produce a finish worked material (wire material).

Thereafter, the finish worked material (wire material) was subjected to a finish heat treatment under the conditions listed in Tables 3 and 4, thereby obtaining copper alloy plastically-worked materials (copper alloy wire materials) of examples of the present invention and comparative examples.

The obtained copper alloy plastically-worked materials (copper alloy wire materials) were evaluated for the following items.

### (Composition Analysis)

A measurement specimen was collected from the obtained ingot, Mg was measured by inductively coupled plasma atomic emission spectrophotometry, and other elements were measured using a glow discharge mass spectrometer (GD-MS). Further, H was analyzed by a thermal conductivity method, and O, S, and C were analyzed by an infrared absorption method.

Further, the measurement was performed at two sites, the center portion of the specimen and the end portion of the specimen in the width direction, and the larger content was defined as the amount of the sample. As a result, it was confirmed that the component compositions were as listed in Tables 1 and 2.

### (Tensile Strength)

#9 test pieces specified in JIS Z 2201 were collected, and the tensile strength of the copper alloy plastically-worked material (copper alloy wire material) in the longitudinal direction (wire-drawing direction) was measured by the tensile test method of JIS Z 2241.

### (Heat-Resistant Temperature)

The heat-resistant temperature was evaluated by obtaining an isochrone softening curve by performing a tensile test on the copper alloy plastically-worked material after one hour of the heat treatment in conformity with JCBA T325:2013 of Japan Copper and Brass Association.

In the present embodiment, the heat-resistant temperature is a heat treatment temperature, at which a strength reaches 0.8×T₀ with respect to a strength T₀ before a heat treatment, after the heat treatment at 100° C. to 800° C. for a heat treatment time of 60 minutes. Further, the strength T₀ before the heat treatment is a value measured at room temperature (15° C. to 35° C.).

### (Electrical Conductivity)

The measurement was carried out with a measured length of 1 m by a four-terminal method in conformity with JIS C 3001, and the electric resistance value was obtained. The electrical conductivity was calculated by acquiring the volume resistivity from the measured electric resistance value and the volume acquired from the wire diameter and the measured length.

### (Low-Angle Grain Boundary and Subgrain Boundary Length Ratio)

The low-angle grain boundary and subgrain boundary length ratio was acquired in the following manner by using a cross section transverse to the longitudinal direction (wire-drawing direction) of the copper alloy plastically-worked material (copper alloy wire material) as an observation surface with an EBSD measuring device and OIM analysis software.

The observation surface was subjected to mechanical polishing using waterproof abrasive paper and diamond abrasive grains and to finish polishing using a colloidal silica solution. Thereafter, the observation surface with a measurement area of 1,000 μm² or greater at an electron beam acceleration voltage of 15 kV was observed by an EBSD measuring device (Quanta FEG 450, manufactured by FEI, OIM Data Collection, manufactured by EDAX/TSL (currently AMETEK)) and analysis software (OIM Data Analysis ver 7.3.1, manufactured by EDAX/TSL (currently AMETEK)), a measurement point where the CI value at every measurement interval of 0.1 μm was 0.1 or less was removed, the orientation difference between crystal grains was analyzed, a boundary having 15° or greater of the orientation difference between neighboring measurement points was assigned as a crystal grain boundary, and an average grain size A was acquired according to Area Fraction using data analysis software OIM.

After that, the observation surface was measured at every measurement interval which was 1/10 or less of the average grain size A, a measurement point where the CI value analyzed by data analysis software OIM was 0.1 or less was removed and analyzed in a measurement area of 1,000 μm² or greater in a plurality of visual fields such that a total of 1,000 or more crystal grains were included, and the length of a low-angle grain boundary having 2° or greater and 15° or less of the orientation difference between neighboring measurement points and a subgrain boundary was defined as L_{LB} and the length of a high-angle grain boundary having greater than 15° of the orientation difference between neighboring measurement points was defined as Lin, and thus the low-angle grain boundary and subgrain boundary length ratio in all grain boundaries L_{LB}/(L_{LB}+L_{HB}) was acquired. Further, in a case where the cross-sectional area transverse to the longitudinal direction of the copper alloy plastically-worked material is less than 1,000 μm², observation is made in a plurality of visual fields, and the total area of the observation visual fields is set to 1,000 μm² or greater.

### (Texture)

The area ratio in orientation within 15° from the (100) plane orientation and the area ratio in orientation within 15° from the (123) plane orientation was measured by an EBSD measuring device and OIM analysis software based on the above-described measured results.

TABLE 1

| | | | | | | | | | | | | | | | [S + P + | [Mg]/[S + |
|---|---|---|---|---|---|---|---|---|---|---|---|---|---|---|---|---|
| | | Component composition (mass ratio) | | | | | | | | | | | | | Se + Te + | P + Se + |
| | | | | Impurities | | | | | | | | | | | Sb + Bi + | Te + Sb + |
| | | Mg | Ag | S | P | Se | Te | Sb | Bi | As | H | O | C | | As] | Bi + |
| | | ppm | ppm | ppm | ppm | ppm | ppm | ppm | ppm | ppm | ppm | ppm | ppm | Cu | ppm | As] |
| Examples of | 1 | 11 | 5 | 2.1 | 3.3 | 2.1 | 2.2 | 0.5 | 1.5 | 0.2 | 0.8 | 1.8 | 1.3 | Balance | 11.9 | 0.9 |
| present | 2 | 17 | 6 | 2.8 | 1.2 | 1.7 | 0.9 | 0.5 | 1.9 | 4.9 | 1.5 | 0.9 | 0.8 | Balance | 13.9 | 1.2 |
| invention | 3 | 23 | 22 | 8.7 | 9.1 | 1.6 | 2.2 | 1.5 | 3.3 | 1.4 | 3.7 | 1.8 | 8.7 | Balance | 27.8 | 0.8 |
| | 4 | 35 | 17 | 6.5 | 2.4 | 0.8 | 1.4 | 1.1 | 4.8 | 0.3 | 0.3 | 1.2 | 0.7 | Balance | 17.3 | 2.0 |
| | 5 | 42 | 0 | 3.6 | 0.7 | 0.9 | 4.7 | 1.4 | 0.9 | 0.7 | 0.7 | 1.3 | 0.7 | Balance | 12.9 | 3.3 |
| | 6 | 48 | 9 | 2.6 | 2.1 | 1.5 | 0.7 | 1.6 | 0.8 | 1.1 | 1.6 | 1.4 | 0.6 | Balance | 10.4 | 4.6 |
| | 7 | 51 | 11 | 5.4 | 1.9 | 1.6 | 1.4 | 1.6 | 1.1 | 1.5 | 0.8 | 0.3 | 0.9 | Balance | 14.5 | 3.5 |
| | 8 | 53 | 8 | 6.8 | 0.7 | 0.9 | 1.4 | 0.6 | 0.8 | 0.2 | 1.4 | 1.2 | 0.9 | Balance | 11.4 | 4.6 |
| | 9 | 56 | 10 | 3.4 | 0.8 | 1.2 | 1.9 | 1.4 | 0.6 | 0.1 | 0.9 | 1.2 | 1.9 | Balance | 9.4 | 6.0 |
| | 10 | 57 | 13 | 3.6 | 1.3 | 0.6 | 0.5 | 1.6 | 0.8 | 1.2 | 0.2 | 1.4 | 0.7 | Balance | 9.6 | 5.9 |
| | 11 | 59 | 11 | 4.7 | 1.1 | 1.9 | 0.6 | 0.8 | 1.2 | 1.6 | 0.4 | 1.4 | 0.8 | Balance | 11.9 | 5.0 |
| | 12 | 61 | 11 | 1.8 | 1.1 | 1.6 | 1.4 | 1.8 | 1.8 | 0.3 | 1.7 | 1.9 | 0.5 | Balance | 9.8 | 6.2 |

TABLE 2

| | Component composition (mass ratio) | | | | | | | | | | | | | | | |
|---|---|---|---|---|---|---|---|---|---|---|---|---|---|---|---|---|
| | | | | | | | | | | | | | | | [S + P + | [Mg]/[S + |
| | | | | Impurities | | | | | | | | | | | Se + Te + | P + Se + |
| | Mg | | Ag | S | P | Se | Te | Sb | Bi | As | H | O | C | | Sb + Bi + | Te + Sb + |
| | ppm | | ppm | ppm | ppm | ppm | ppm | ppm | ppm | ppm | ppm | ppm | ppm | Cu | As] ppm | Bi + As] |
| Examples of | 13 | 62 | 14 | 5.1 | 1.2 | 1.6 | 0.9 | 1.1 | 0.2 | 1.3 | 1.2 | 1.2 | 0.7 | Balance | 11.4 | 5.4 |
| present | 14 | 64 | 9 | 4.9 | 0.9 | 1.5 | 1.1 | 0.4 | 1.5 | 1.7 | 0.6 | 0.8 | 1.8 | Balance | 12.0 | 5.3 |
| invention | 15 | 66 | 8 | 2.2 | 2.3 | 0.8 | 1.3 | 1.2 | 0.4 | 1.4 | 1.3 | 1.6 | 0.7 | Balance | 9.6 | 6.9 |
| | 16 | 69 | 7 | 1.2 | 0.8 | 1.2 | 2.3 | 0.6 | 0.2 | 1.5 | 0.6 | 1.3 | 3.2 | Balance | 7.8 | 8.8 |
| | 17 | 77 | 17 | 9.8 | 1.2 | 4.8 | 0.9 | 0.9 | 0.3 | 0.2 | 1.8 | 11.0 | 0.8 | Balance | 18.1 | 4.3 |
| | 18 | 83 | 15 | 4.5 | 6.4 | 2.2 | 2.1 | 4.6 | 1.9 | 2.1 | 9.6 | 1.4 | 10.0 | Balance | 23.8 | 3.5 |
| | 19 | 94 | 10 | 0.7 | 0.6 | 0.3 | 0.4 | 0.2 | 0.3 | 0.3 | 2.1 | 42.0 | 0.7 | Balance | 2.8 | 33.6 |
| | 20 | 100 | 4 | 0.7 | 0.8 | 0.2 | 0.1 | 0.1 | 0.1 | 0.1 | 1.2 | 75.0 | 5.2 | Balance | 2.1 | 47.6 |
| Comparative | 1 | 7 | 11 | 4.6 | 2.6 | 2.1 | 0.6 | 0.8 | 1.1 | 1.3 | 1.3 | 0.7 | 0.9 | Balance | 13.1 | 0.5 |
| examples | 2 | 2355 | 9 | 3.6 | 2.4 | 0.9 | 0.5 | 0.8 | 1.1 | 4.8 | 1.5 | 12.0 | 4.2 | Balance | 14.1 | 167.0 |
| | 3 | 54 | 11 | 8.4 | 7.6 | 4.3 | 4.2 | 4.1 | 4.7 | 4.3 | 1.5 | 1.9 | 1.0 | Balance | 37.6 | 1.4 |
| | 4 | 24 | 16 | 7.1 | 7.9 | 2.8 | 2.9 | 2.1 | 1.8 | 2.1 | 0.8 | 2.3 | 0.2 | Balance | 26.7 | 0.4 |

TABLE 3

| | | Production step | | | | | |
|---|---|---|---|---|---|---|---|
| | | | | | | Rough | |
| | | | | | | working | |
| | | | | Hot working | | Cross- | Intermediate heat |
| | | Homogenizing/ solutionizing | | | Extrusion | sectional | treatment |
| | | Temperature | Time | Temperature | ratio | area reduction | Temperature |
| | | ° C. | sec. | ° C. | — | ratio % | ° C. |
| Examples | 1 | 800 | 3600 | 600 | 50 | 20 | 300 |
| of present | 2 | 500 | 1800 | 800 | 50 | 30 | 200 |
| invention | 3 | 600 | 1800 | 700 | 6000 | 80 | 400 |
| | 4 | 600 | 3600 | 600 | 80 | 40 | 400 |
| | 5 | 500 | 3600 | 1000 | 200 | 30 | 200 |
| | 6 | 700 | 3600 | 700 | 2000 | 50 | 600 |
| | 7 | 800 | 3600 | 600 | 2000 | 20 | 800 |
| | 8 | 800 | 1800 | 1000 | 100 | 20 | 200 |
| | 9 | 500 | 3600 | 1000 | 5000 | 20 | 400 |
| | 10 | 700 | 1800 | 600 | 200 | 60 | 500 |
| | 11 | 700 | 3600 | 700 | 800 | 50 | 200 |
| | 12 | 700 | 3600 | 800 | 6000 | 80 | 400 |

| | | Production step | | | | | |
|---|---|---|---|---|---|---|---|
| | | | | Pre-finish | | | |
| | | | | working | | | |
| | | Intermediate heat | | Cross- | | | Cross- |
| | | treatment | | sectional | Finish heat treatment | | sectional |
| | | Time | Cooling | area reduction | Temperature | Time | area |
| | | sec. | method | ratio % | ° C. | sec. | mm² |
| Examples | 1 | 3600 | Air | 10 | 350 | 1 | 20 |
| of present | | | cooling | | | | |
| invention | 2 | 86400 | Water | 50 | — | — | 7.1 |
| | | | quenching | | | | |
| | 3 | 1800 | Air | 5 | 300 | 5 | 0.000079 |
| | | | cooling | | | | |
| | 4 | 1800 | Water | 70 | 200 | 3600 | 0.000079 |
| | | | quenching | | | | |
| | 5 | 43200 | Air | 30 | — | — | 3.1 |
| | | | cooling | | | | |
| | 6 | 60 | Water | 60 | 300 | 5 | 0.20 |
| | | | quenching | | | | |
| | 7 | 5 | Water | 99.99 | 350 | 1 | 0.000079 |
| | | | quenching | | | | |
| | 8 | 86400 | Air | 40 | 250 | 60 | 7.1 |
| | | | cooling | | | | |
| | 9 | 3600 | Water | 80 | 300 | 5 | 0.00049 |
| | | | quenching | | | | |
| | 10 | 60 | Air | 20 | — | — | 3.1 |
| | | | cooling | | | | |
| | 11 | 43200 | Water | 40 | 250 | 60 | 0.20 |
| | | | quenching | | | | |
| | 12 | 1800 | Water | 80 | 350 | 1 | 0.00049 |
| | | | quenching | | | | |

TABLE 4

| | | Production step | | | | | |
|---|---|---|---|---|---|---|---|
| | | | | | | Rough | |
| | | | | | | working | Intermediate |
| | | | | Hot working | | Cross- | heat |
| | | Homogenizing/solutionizing | | | Extrusion | sectional | treatment |
| | | Temperature | Time | Temperature | ratio | area reduction | Temperature |
| | | ° C. | sec. | ° C. | — | ratio % | ° C. |
| Examples of | 13 | 800 | 1800 | 1000 | 5000 | 20 | 800 |
| present | 14 | 800 | 3600 | 800 | 1000 | 60 | 200 |
| invention | 15 | 600 | 1800 | 700 | 200 | 20 | 400 |
| | 16 | 500 | 1800 | 600 | 3000 | 80 | 300 |
| | 17 | 600 | 3600 | 800 | 6000 | 20 | 700 |
| | 18 | 800 | 1800 | 700 | 100 | 40 | 300 |
| | 19 | 700 | 1800 | 600 | 80 | 60 | 300 |
| | 20 | 500 | 3600 | 800 | 800 | 30 | 800 |
| Comparative | 1 | 500 | 3600 | 700 | 200 | 10 | 400 |
| examples | 2 | 500 | 1800 | 600 | 50 | 90 | 400 |
| | 3 | 800 | 1800 | 700 | 2000 | 20 | 200 |
| | 4 | 800 | 3600 | 600 | 6000 | 50 | 600 |

| | | Production step | | | | | |
|---|---|---|---|---|---|---|---|
| | | | | Pre-finish | | | |
| | | | | working | | | |
| | | Intermediate | | Cross- | Finish heat | | Cross- |
| | | heat treatment | | sectional | treatment | | sectional |
| | | Time | Cooling | area reduction | Temperature | Time | area |
| | | sec. | method | ratio % | ° C. | sec. | mm² |
| Examples of | 13 | 5 | Air | 30 | 300 | 5 | 0.0020 |
| present | | | cooling | | | | |
| invention | 14 | 86400 | Water | 70 | — | — | 0.20 |
| | | | quenching | | | | |
| | 15 | 1800 | Water | 60 | — | — | 3.1 |
| | | | quenching | | | | |
| | 16 | 3600 | Water | 99.9 | 200 | 3600 | 0.000079 |
| | | | quenching | | | | |
| | 17 | 10 | Water | 90 | 250 | 60 | 0.00049 |
| | | | quenching | | | | |
| | 18 | 3600 | Water | 50 | 350 | 1 | 3.1 |
| | | | quenching | | | | |
| | 19 | 1800 | Air | 20 | 250 | 60 | 0.79 |
| | | | cooling | | | | |
| | 20 | 10 | Water | 99 | — | — | 0.000079 |
| | | | quenching | | | | |
| Comparative | 1 | 1800 | Air | 10 | 250 | 60 | 7.1 |
| examples | | | cooling | | | | |
| | 2 | 3600 | Water | 50 | — | — | 0.79 |
| | | | quenching | | | | |
| | 3 | 43200 | Air | 30 | 250 | 60 | 0.0079 |
| | | | cooling | | | | |
| | 4 | 60 | Water | 60 | 350 | 1 | 0.0020 |
| | | | quenching | | | | |

TABLE 5

| | | Texture | | | Characteristics | | |
|---|---|---|---|---|---|---|---|
| | | | Area ratio of | Area ratio of | | | Heat- |
| | | | crystals having | crystals having | Electrical | Tensile | resistant |
| | | | (100) plane | (123) plane | conductivity | strength | temperature |
| | | L_{LB}/(L_{LB} + L_{HB}) | orientation % | orientation % | % IACS | MPa | ° C. |
| Examples of | 1 | 17 | 55 | 7 | 99.9 | 212 | 155 |
| present | 2 | 73 | 42 | 43 | 99.6 | 245 | 164 |
| invention | 3 | 7 | 58 | 3 | 99.5 | 208 | 188 |
| | 4 | 75 | 29 | 63 | 99.3 | 261 | 199 |
| | 5 | 61 | 48 | 21 | 99.0 | 315 | 402 |
| | 6 | 74 | 35 | 55 | 98.7 | 387 | 379 |
| | 7 | 78 | 12 | 87 | 98.5 | 437 | 355 |
| | 8 | 69 | 45 | 33 | 98.5 | 349 | 381 |
| | 9 | 73 | 25 | 74 | 98.6 | 423 | 358 |
| | 10 | 38 | 52 | 16 | 98.5 | 281 | 415 |
| | 11 | 71 | 44 | 31 | 98.5 | 355 | 381 |
| | 12 | 76 | 23 | 75 | 98.4 | 429 | 357 |

TABLE 6

| | | Texture | | | Characteristics | | |
|---|---|---|---|---|---|---|---|
| | | | Area ratio of | Area ratio of | | | Heat- |
| | | | crystals having | crystals having | Electrical | Tensile | resistant |
| | | | (100) plane | (123) plane | conductivity | strength | temperature |
| | | L_{LB}/(L_{LB} + L_{HB}) | orientation % | orientation % | % IACS | MPa | ° C. |
| Examples of | 13 | 64 | 49 | 25 | 98.3 | 321 | 399 |
| present | 14 | 75 | 30 | 65 | 98.3 | 402 | 375 |
| invention | 15 | 74 | 37 | 54 | 98.1 | 388 | 375 |
| | 16 | 77 | 15 | 87 | 97.8 | 434 | 351 |
| | 17 | 76 | 20 | 83 | 97.7 | 430 | 360 |
| | 18 | 74 | 41 | 41 | 97.5 | 378 | 369 |
| | 19 | 36 | 51 | 15 | 97.4 | 294 | 409 |
| | 20 | 78 | 17 | 86 | 98.2 | 431 | 356 |
| Comparative | 1 | 18 | 54 | 8 | 100.0 | 175 | 139 |
| examples | 2 | 73 | 41 | 41 | 82.6 | 340 | 401 |
| | 3 | 62 | 49 | 20 | 98.3 | 322 | 138 |
| | 4 | 73 | 34 | 55 | 99.4 | 379 | 140 |

In Comparative Example 1, since the amount of Mg was less than the range of the present invention, the strength and the heat resistance were insufficient.

In Comparative Example 2, since the amount of Mg was greater than the range of the present invention, the electrical conductivity was low.

In Comparative Example 3, since the total amount of S, P, Se, Te, Sb, Bi, and As was greater than 30 mass ppm, the heat resistance was insufficient.

In Comparative Example 4, since the mass ratio of [Mg]/[S+P+Se+Te+Sb+Bi+As] was less than 0.6, the heat resistance was insufficient.

On the contrary, in Examples 1 to 20 of the present invention, it was confirmed that the heat resistance, the electrical conductivity, and the strength were improved in a well-balanced manner.

As described above, according to the examples of the present invention, it was confirmed that a copper alloy plastically-worked material with high strength, high electrical conductivity, and excellent heat resistance can be provided.

1. A copper alloy plastically-worked material comprising:
Mg in an amount of greater than 10 mass ppm and 100 mass ppm or less; and
a balance of Cu and inevitable impurities, wherein
the inevitable impurities comprise:
S in an amount of 10 mass ppm or less,
P in an amount of 10 mass ppm or less,
Se in an amount of 5 mass ppm or less,
Te in an amount of 5 mass ppm or less,
Sb in an amount of 5 mass ppm or less,
Bi in an amount of 5 mass ppm or less, and
As in an amount of 5 mass ppm or less,
a total amount of S, P, Se, Te, Sb, Bi, and As is 30 mass ppm or less, and
in a case where the amount of Mg is defined as [Mg] and the total amount of S, P, Se, Te, Sb, Bi, and As is defined as [S+P+Se+Te+Sb+Bi+As], a mass ratio of [Mg]/[S+P+Se+Te+Sb+Bi+As] is 0.6 or greater and 50 or less, an electrical conductivity is 97% IACS or greater, a tensile strength is 200 MPa or greater, and a heat-resistant temperature is 150° C. or higher.

2. The copper alloy plastically-worked material according to claim 1,
wherein a cross-sectional area of a cross section transverse to a longitudinal direction of the copper alloy plastically-worked material is in a range of 50 m² or greater and 20 mm² or less.

3. The copper alloy plastically-worked material according to claim 1, further comprising:
Ag in an amount of 5 mass ppm or greater and 20 mass ppm or less.

4. The copper alloy plastically-worked material according to claim 1,
wherein the inevitable impurities further comprise;
Hi in an amount of 10 mass ppm or less,
O in an amount of 100 mass ppm or less, and
C in an amount of 10 mass ppm or less.

5. The copper alloy plastically-worked material according to claim 1,
wherein in a case where a measurement area of 1,000 μm² or greater in a cross section transverse to a longitudinal direction of the copper alloy plastically-worked material is ensured and defined as an observation surface of an EBSD method, a measurement point where a CI value at every measurement interval of 0.1 μm is 0.1 or less is removed, an orientation difference between crystal grains is analyzed, a boundary having 15° or greater of an orientation difference between neighboring measurement points is assigned as a crystal grain boundary, an average grain size A is acquired according to Area Fraction, measurement is performed at every measurement interval which is 1/10 or less of the average grain size A, a measurement area of 1,000 μm² or greater in a plurality of visual fields is ensured such that a total of 1,000 or more crystal grains are included, and defined as an observation surface, a measurement point where a CI value analyzed by data analysis software OIM is 0.1 or less is removed and analyzed, and the length of a low-angle grain boundary and a subgrain boundary having 2° or greater and 15° or less of an orientation difference between neighboring measurement points is defined as L_{LB} and a length of a high-angle grain boundary having greater than 15° of an orientation difference between neighboring measurement points is defined as L_{HB},
a relationship of L_{LB}/(L_{LB}+L_{HB})>5% is satisfied.

6. The copper alloy plastically-worked material according to claim 1,
wherein in a cross section transverse to a longitudinal direction of the copper alloy plastically-worked material, an area ratio of crystals having (100) plane orientation is 60% or less, and an area ratio of crystals having (123) plane orientation is 2% or greater.

7. A copper alloy wire material consisting of:
the copper alloy plastically-worked material according to claim 1,
wherein a diameter of a cross section transverse to a longitudinal direction of the copper alloy plastically-worked material is in a range of 10 μm or greater and 5 mm or less.

8. A component for electronic/electrical devices, consisting of:
the copper alloy plastically-worked material according to claim 1.

9. A terminal consisting of:
the copper alloy plastically-worked material according to claim 1.
